(19) United States
(12) Patent Application Publication
(10) Pub. No.: US 2004/0071829 A1
(43) Pub. Date: Apr. 15, 2004

(54) Shaped cookie intermediates having interior designs

(76) Inventors: Susan M. Hayes-Jacobson, Minneapolis, MN (US); Julie A. Piasecki, Coon Rapids, MN (US); Glenn O. Rasmussen, Champlin, MN (US); Cara J. Sekerak, Lakeville, MN (US); Julia M. Schmelzer, St. Louis Park, MN (US)

Correspondence Address: GENERAL MILLS, P O BOX 1113, Minneapolis, MN, 55440, US

(21) Appl. No.: 10/267,472

(22) Filed: Oct. 9, 2002

(51) Int. Cl. A23G 3/00

(52) U.S. Cl. 426/74; 426/94

(57) ABSTRACT

The present invention relates to shaped cookie dough intermediates provided in an easy to use and convenient format, having an integral design element which can be provided on a commercially produced scale. The shaped cookie dough intermediate can be produced in various configurations and have any sort of internally, preformed design element. More specifically, the present invention is directed to the creation of individual cookie dough intermediates that have predetermined shapes other than generally circular and which include an interior arrangement of other dough shapes, designs or elements in order to create a composite cookie dough intermediate that is illustrative of a particular theme or event, such as holiday, special occasion, sporting event and the like.

### CROSS-REFERENCES TO RELATED APPLICATIONS

None.

### FIELD OF THE INVENTION

The present invention relates to shaped cookie dough intermediates provided in an easy to use and convenient format, having an integral design element which can be provided on a commercially produced scale. The shaped cookie dough intermediate can be produced in various configurations and have any sort of internally, preformed design element. More specifically, the present invention is directed to the creation of individual cookie dough intermediates that have predetermined shapes other than generally circular and which include an interior arrangement of other dough shapes, designs or elements in order to create a composite cookie dough intermediate that is illustrative of a particular theme or event, such as holiday, special occasion, sporting event and the like.

### BACKGROUND OF THE INVENTION

There are currently a number of commercial offerings for ready to bake refrigerated cookies. One such exemplary offering includes sheets of scored, grooved or perforated blocks of cookie dough such as those illustrated in U.S. Pat. Nos. 6,280,783, 6,284,295 and 6,312,743. The scored dough sheet is provided in a package that may consist of a plate and outer wrapping. In use the consumer removes the sheet of dough from the package and breaks off individual squares or pieces. The pieces or squares are then placed on a cookie sheet or other baking vessel and upon the application of heat the cookies are baked. While the foregoing product provides a level of convenience, there are a number of drawbacks associated with this particular product. Insufficient scoring can cause irregular pieces to break off, creating cookies that are different in size or have an irregular appearance from that of the rest of the cookies on the sheet or pan. The breaking of the cookie pieces can also cause crumbling of the product when the individual cookies are separated from the sheet leaving the preparer with a mess to have to clean up. Moreover, the breaking of the cookies from the block requires the user to contact the dough with more hand surface area, due to the increased pressure needed to break the block, thereby soiling one's hands, which if in a hurry can be an additional distraction to the consumer.

Another example of refrigerated cookie dough products is shown in U.S. Pat. No. 5,171,599 (commonly assigned) in which edible bits, such as candy pieces, are embedded in the cookie dough. Again, the dough is removed from its packaging and baked. In addition, the decorations, while adding a pleasing aesthetic appearance to the cookie are visible only on one side of the cookie. Such that, if the cookie becomes inverted, the viewer cannot witness the decorative elements.

U.S. Pat. No. 5,620,713 (commonly assigned) discloses an extrusion die that is useful in creating a generally round cookie having an internal design. The design is created through the use of a plural dough streams that are fed through a die and extruded into a dough log that is then packaged in a tube. In use, the consumer then unwraps the log and slices the log into individual cookies. While this product offers convenience, it suffers from some drawbacks. The user is required to unwrap the dough log from the package and then the unused portion of the log must be wrapped to protect from spoiling. In addition, the user is required to slice off individual cookies from the log, which can lead to odd shaped cookies or cookies of different thickness, resulting in uneven baking of the cookies. That is, some cookies may be overdone, those that are sliced to thinly and some underdone, those that are sliced to thick.

U.S. Pat. No. 3,228,356 discloses the use of three separate pastry streams to produce a cookie having a particular design appearing on one surface or on the face of the cookie. Initially, a stream of pastry dough is extruded and a second stream of dough is extruded “thence out of the tubular letters ahead of the chocolate stream [first stream].” The third stream is extruded into the areas around the lettering [second stream] to produce an “extruded product having the transverse configuration.” Thus, the '356 reference produces a cookie to which a design is applied on to a single surface of the cookie. That is, the design is not integral with the cookie in that the decoration comes out ahead of the base, providing a single sided decoration or a laminated arrangement or appearance. Thus, once the cookie is flipped over, one only sees the backside or solid chocolate side of the cookie, minimizing the value of applying a design to the cookie. Such laminated cookies can also appear to have a “fabricated” look to them, in that each layer of the cookies is visible rather than a homogenous structure or configuration, in which the design element is integrated into the cookie itself.

There are many varieties of decorated cookies can these products can be found at any bakery, retail food store and the like. These cookies are typically created from a single type of dough and then cookie cutters, having the particular desired configuration of the final shape, are then pressed into the dough to produce a cookie having that shape, the matrix around the shape is then stripped away and the cookie is then baked. These cookies may have decorative elements added to them such as frosting, candy sprinkles, food coloring and the like. Decorative cookies made in this fashion suffer from a number of drawbacks, in that they are made individually or in very small batches and can be very time consuming as well as expensive to produce. Laminations may also be prone to separation through handling or ineffective bonding.

Another problem with cookies prepared by the foregoing process is that the decoration is only visible on one side of the cookie. That is, the design does not permeate each of the cookie surfaces and deliberate positioning of the cookies or “facing” must be done in the display case or package to show the decoration to prospective customers. As such, if the cookie become inverted in the package, cookie jar, gift box or the like, the effort that went into creating the decoration is lost as the decoration is not visible to the consumer.

In a commercial environment, a cookie puck having a design only on one side, can become inverted due to transfers from various conveyors thereby hiding the design, when the cookie puck is flipped over, due to differential speeds of the conveyor belts or variations in height, thereby causing the entire package in which the inverted cookies appear to be rejected. Correction of the situation precipitates manual intervention to fix the problem and incur additional costs to correct the problem.

Another problem with such prior art cookies is that the candy sprinkles or frosting and decorations can fall off the cookie, thereby distorting the initial design being offered by the manufacturer or baker. This again diminishes the value of the offering in the eyes of the consumer leaving the retailer with cookies that may no longer be salable as well as a display case littered with the decorative particulate matter that must be cleaned and removed at each closing of the retail establishment.

In other situations where food coloring is used to decorate the particular article, the food coloring can bleed into unintended areas making the design difficult to visualize. In addition, if the cookies with the dye or coloring are handled shortly after the coloring has been applied, such as with packaging, the food coloring can come off on the packaging or transfer to other cookies within the package, making the product look spoiled or unpalatable.

Thus what is needed therefore, is a shaped cookie dough intermediate, that can be produced at production speeds and that has an integral design formed from multiple dough streams that is visible from both sides of the dough product and which does not suffer from the drawbacks enumerated above.

All publications, patents and patent applications referred to in this specification are incorporated herein by reference.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

In one embodiment of the present invention, a generally non-circular cookie dough intermediate having an integral design element is described and includes a dough intermediate, having first and second sides. The dough intermediate has at least a first and second portion with the first portion, which is made of a dough material, of the dough intermediate provided in an amount of up to 80% of the total of the dough intermediate. The first portion of the dough intermediate has a unique first property. The second portion of the dough intermediate is also dough like and has a second property that is distinct from the first property. The first and second portions of the dough intermediate combine together to form a dough intermediate having a shaped external configuration other than circular and an integral design element which is visible on each of the first and second sides of the dough intermediate.

A further embodiment of the present invention relates to a generally non-circular cookie dough intermediate having an integral design and includes a dough intermediate that has first and second sides and an external surface extending generally in a non-circumferential fashion. A design element is provided and is integral with the dough intermediate. The design element includes a background portion and at least one highlight portion. Both the background portion and the highlight portion are visible on each of the first and second sides of the dough intermediate. The background portion makes up a majority of the dough intermediate. The dough intermediate and the design element combine together to illustrate a particular theme.

A still further embodiment of the present invention relates to a method for making a generally non-circular cookie dough intermediate that has an integral design element, and includes the steps of first providing a set of predetermined dough ingredients to produce at least first and second doughs. Each of the doughs have a particular property and a specific dough density. The first dough makes up a majority of the first and second doughs and the doughs cooperate to form a generally non-circumferentially extending cookie dough intermediate shape and an integral design element. Next, the first and second doughs are extruded into a rope having a non-circular external configuration and an internal design element. Next, the rope is sliced to create a generally non-circular shaped cookie dough intermediate that has a thickness ranging from about ¼″ to 1.″ The non-circular cookie dough intermediates also has first and second sides and the integral design element is visible on each of the sides. The individual cookie pucks are then frozen and then placed into a package.

There are a number of permutations possible for each of the foregoing embodiments and one with skill in the art would readily recognize such variations.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 is a front view of a shaped cookie dough intermediate that has been prepared in connection with the invention;

FIG. 2 is a cross sectional view of the shaped cookie dough intermediate prepared in connection with the present invention;

FIG. 3 is a front view of a further cookie dough intermediate design prepared in accordance with the present invention;

FIG. 4 is a flow diagram illustrating the steps in manufacturing the cookie dough intermediates in accordance with the present invention; and

FIG. 5 is a schematic illustrating the system used in the production of the cookie dough intermediates in accordance with the present invention.

### DETAILED DESCRIPTION OF THE INVENTION

As used herein the term “dough intermediate” or “shaped cookie dough intermediate” refers to an article that is in an intermediate condition and requires some further processing such as baking, cooking or frying to change the intermediate into a condition that is suitable for consumption.

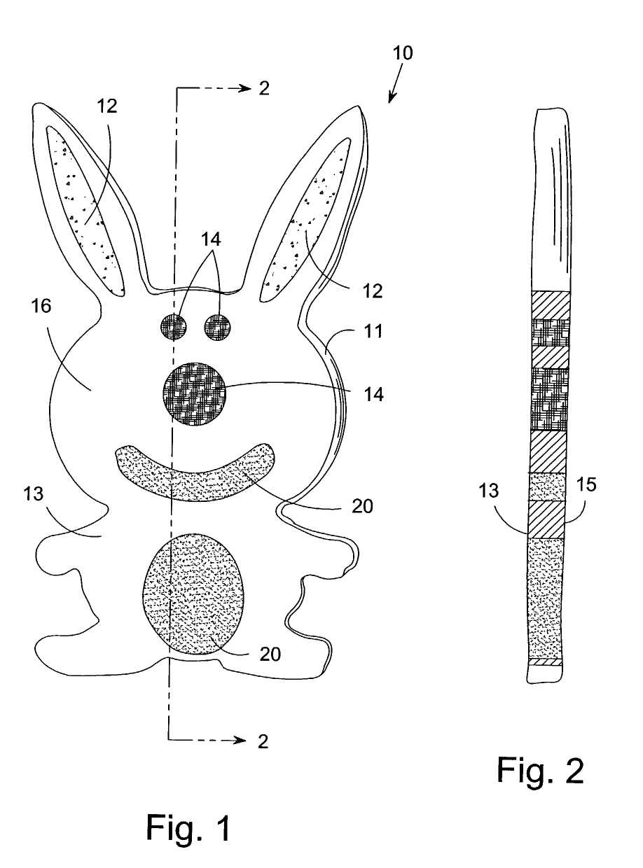

Turning now to FIG. 1, a shaped cookie dough intermediate is generally depicted as 10. The shaped cookie intermediate 10 has an external configuration 11, which is generally non-circular and is provided with first and second sides 13 and 15 (illustrated in FIG. 2). The shaped cookie intermediate 10 is provide with a first portion 16 that is provided in a total amount of the dough intermediate of up to about 80%. Preferably, the first portion 16 is provided in an amount of the total intermediate ranging from 30 to 66% and more preferably from 40 to 60%.

A second portion 12, providing a highlight or feature portion, of the dough intermediate 10 is provided in an amount ranging from 1 to 60% and more preferably from 10 to 30%. A third portion 14 and even a fourth portion 20, which again may be used in highlighting or providing additional features to accentuate the shape, may also be provided along with the dough intermediate 10 and is provided in an amount generally ranging from 1 to 40% (typically less than 40%) of the total dough intermediate and more preferably in the amount of 2 to 10% of the shaped cookie dough intermediate. It should be understood that the second, third and fourth portions 12, 14 and 20, instead of being distinct dough streams could be identical dough streams providing only first and second portions of the intermediate, providing two different properties, such as colors, flavors or textures, but in several different areas in order to fully illustrate the internal design. That is, the additional portions could represent the interior portion of the ears, nose, eyes, etc. in the rabbit illustrated in FIG. 1 or other auxiliary features depending on the design. In other embodiments there could be three dough streams, creating three areas, a background and two highlighting or feature areas of the design.

Where three dough portions are used, an exemplary ratio of the first to second to third portions (such as 16, 12 and 14) would include 60:30:10 (for a total of 100% of the amount or volume or surface area of the intermediate). Where four dough portions are used (such as 16, 12, 14 and 20) the ratio of the dough portions to one another may include 50:20:20:10 (100% of the area or surface or volume of the intermediate). Obviously, there are many permutations that can exist in configuring the ratio of dough portions to arrive at the particular aesthetic features of the integral design element and intermediate background or base.

The design may be wholly confined within the background portion or may extend to or beyond the generally non-circumferentially extending edge or be coterminous with the exterior edge. That is, the first portion 16 which makes up a majority of the surface area of the intermediate 10. The term “non-circumferentially extending” means an external edge other than an edge that extends substantially completely in a circular or circumferential fashion.

The first portion 16 is typically representative of the background portion of the generally non-circular shaped cookie dough intermediate 10 of the present invention and will comprise typically more than one half of the total volume or area of the intermediate 10.

The second 12 and alternatively other portions, such as 14 and 20 will comprise generally less than half of the volume or area of the intermediate 10. In any event, the background portion or first portion 16 and the other portions, such as 12, 14 and 20, combine or cooperate with one another to facilitate the recognition of the theme. Obviously, one would recognize that the larger portion may not have to be the background portion but could comprise other substantial areas of the character, theme or design to be illustrated such as the body of an animal or the leafs and branches of a tree.

The first portion 16 of the dough intermediate 10, is provided with a first property. That property may relate to coloration, texture (such as creating a crispy texture upon cooking or a chewier texture after baking), taste (such as a higher or lower level of sweetness than the other portions 12, 14 and 20 of the intermediate, if provided) or even different flavors to accentuate the decoration of the shaped cookie dough intermediate 10. For example, each of the portions of the dough, such as a first portion and a second portion 16 and 12 could each have a different flavor, one might be an orange flavor and the other might be a cinnamon flavor.

Each of the first through fourth portions 12, 14, 16 and 20 of the shaped cookie dough intermediate may be applied in any number of configurations depending on the particular orientation of the final design or season or event with which the cookie dough intermediate is being offered.

Turning to FIG. 2, a cross section of the shaped cookie dough intermediate is provided. In FIG. 2 each of the dough portions 12, 14, 16 and 20 extend all the way through the shaped cookie intermediate 10 such that each of the portions 12, 14, 16 and 20 of the design are visible on each side 13 and 15 of the non-circumferentially exterior of the shaped cookie dough intermediate.

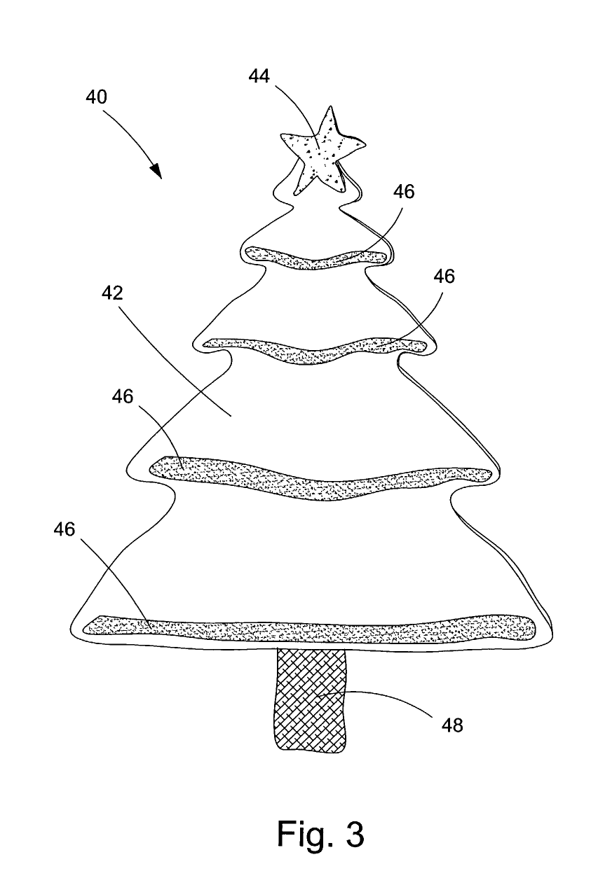

The numeral 40 generally depicts the shape of the cookie dough intermediate provided in FIG. 3. In this depiction, the shaped cookie dough intermediate is an evergreen tree that may be reminiscent of certain holiday celebrations. It should be understood that any generally non-circular shape could be produced in accordance with the present invention. That is, shaped cookie dough intermediates could be produced for sporting events, holiday occasions, seasonal recognitions, human and animal figures, inanimate symbols and the like.

The shaped cookie dough intermediate 40 in FIG. 3 may include any number of dough portions and in this example is provided with first, second, third and fourth portions 42, 44, 46 and 48. The first portion 42 being provided in an amount of up to 66% of the total amount of the dough intermediate. The second, third and fourth portions 44, 46 and 48 can be provided in ranges from 1 to 40%, and preferably from 2-30% of the total volume of the shaped cookie dough intermediate 40.

Dough formulations, and the ingredients they contain, can differ depending on the requirements of the finished product. However, most doughs generally have a number of ingredients in common, examples of some such common ingredients are described and illustrated in more detail below.

The dough of the invention generally contains a grain constituent that contributes to the structure of the dough. Different grain constituents lend different texture, taste and appearance to a baked good. Flour is the most commonly used grain constituent in baked goods, and in most baked foods is the primary ingredient.

Suitable flours include hard wheat flour, soft wheat flour, corn flour, high amylose flour, low amylose flour, and the like. For example, a dough product made with a hard wheat flour will have a more coarse texture than a dough made with a soft wheat flour due to the presence of a higher amount of gluten in hard wheat flour.

The doughs of the invention also generally include leavening agents that increase the volume and alter the texture of the final baked good. Such leavening agents can either be chemical leavening agents or yeast.

Chemical leavening typically involves the interaction of at least one leavening acid and at least one leavening base. The leavening acid generally triggers the release of carbon dioxide from the leavening base upon contact with moisture. The carbon dioxide gas aerates the dough or batter during mixing and baking to provide a light, porous cell structure, fine grain, and a texture with a desirable appearance and palatability.

Sodium bicarbonate, or baking soda, a leavening base, is the primary source of carbon dioxide gas in many chemical-leavening systems. This compound is stable and relatively inexpensive to produce. Other leavening bases include for example potassium bicarbonate, ammonium carbonate and ammonium bicarbonate.

Leavening bases can be modified in order to alter the way in which they work. For example, they can be encapsulated. Encapsulated leavening bases, such as encapsulated baking soda, will tend to delay the onset of the leavening reaction because the encapsulating material must dissolve before the leavening reaction can occur.

Generally, the invention can utilize modified or non-modified leavening bases as part of a chemical leavening system. Specifically, however, one embodiment of the invention utilizes non-encapsulated leavening bases as part of the chemical leavening system.

Leavening acids include sodium or calcium salts of ortho, pyro, and complex phosphoric acids in which at least two active hydrogen ions are attached to the molecule. Baking acids include compounds such as monocalcium phosphate monohydrate (MCP), monocalcium phosphate anhydrous (AMCP), sodium acid pyrophosphate (SAPP), sodium aluminum phosphate (SALP), dicalcium phosphate dehydrate (DPD), dicalcium phosphate (DCP), sodium aluminum sulfate (SAS), glucono-delta-lactone (GDL), and potassium hydrogen tartrate (cream of tartar).

The dough of the invention can also contain additional ingredients. Some such additional ingredients can be used to modify the texture of dough. Texture modifying agents can improve many properties of the dough, such as viscoelastic properties, plasticity, or dough development. Examples of texture modifying agents include fats, emulsifiers, hydrocolloids, and the like.

Shortening helps to improve the volume, grain and texture of the final product. Shortening also has a tenderizing effect and improves overall palatability and flavor of a baked good. Natural shortenings, animal or vegetable, or synthetic shortenings can be used. Generally, shortening is comprised of triglycerides, fats and fatty oils made predominantly of triesters of glycerol with fatty acids. Fats and fatty oils useful in producing shortening include cotton seed oil, ground nut oil, soybean oil, sunflower oil, rapeseed oil, sesame oil, olive oil, corn oil, safflower oil, palm oil, palm kernel oil, coconut oil, or combinations thereof.

Emulsifiers include nonionic, anionic, and/or cationic surfactants that can be used to influence the texture and homogeneity of a dough mixture, increase dough stability, improve eating quality, and prolong palatability. Emulsifiers include compounds such as lecithin, mono- and diglycerides of fatty acids, propylene glycol mono- and diesters of fatty acids, glyceryl-lacto esters of fatty acids, and ethoxylated mono- and diglycerides.

Hydrocolloids are added to dough formulations to increase moisture content, and to improve viscoelastic properties of the dough and the crumb texture of the final product. Hydrocolloids function both by stabilizing small air cells within the batter and by binding to moisture within the dough. Hydrocolloids include compounds such as xanthan gum, guar gum, and locust bean gum.

Dough can also include flavorings such as sweeteners, spices, and specific flavorings such as bread or butter flavoring. Sweeteners include regular and high fructose corn syrup, sucrose (cane or beet sugar), and dextrose, for example. In addition to flavoring the baked good, sweeteners such as sugar can increase the moisture retention of a baked good, thereby increasing its tenderness.

Dough can also include preservatives and mold inhibitors such as sodium salts of propionic or sorbic acids, sodium diacetate, vinegar, monocalcium phosphate, lactic acid and mixtures thereof.

The consistency of the dough must be monitored in that if the dough is too sticky, processing difficulties arise. If the dough is too dry, then issues related to consumer satisfaction, e.g. taste, texture, are created. In one embodiment of the present invention, the amount of sugar is increased from a conventional dough product and the amount of flour is decreased. This creates a dough that is typically more sticky, due to the presence of the additional sugar, and also one that is more desirable from a satisfaction standpoint. In light of the more sticky nature of the dough, additional care must be taken in processing to avoid equipment slow down or even down time for the entire processing line.

If the proper consistency for the shaped cookie dough intermediate is not achieved, the dough will spread out and the desired shape of the dough intermediate will be reduced or even lost, thereby mitigating the aesthetic appearance and value of the intermediate.

The present invention is now illustrated in greater detail by way of the following examples, but it should be understood that the present invention is not to be construed as being limited thereto.

In preparing the preferred dough for use as an intermediate in the present invention the following formulation was used.

| Ingredient | Weight Percent |
|---|---|
| Sugar | 22.6 |
| Shortening | 22.21 |
| Water | 1 |
| Salt | .51 |
| Flour | 41.85 |
| Butter Flavor | .69 |
| Whole Eggs | 10.21 |
| Wey Solids | .38 |
| Soda | .56 |
| Total | 100 |

All percentages and ratios are calculated by weight unless otherwise indicated. All percentages and ratios are calculated based on the total composition unless otherwise stated.

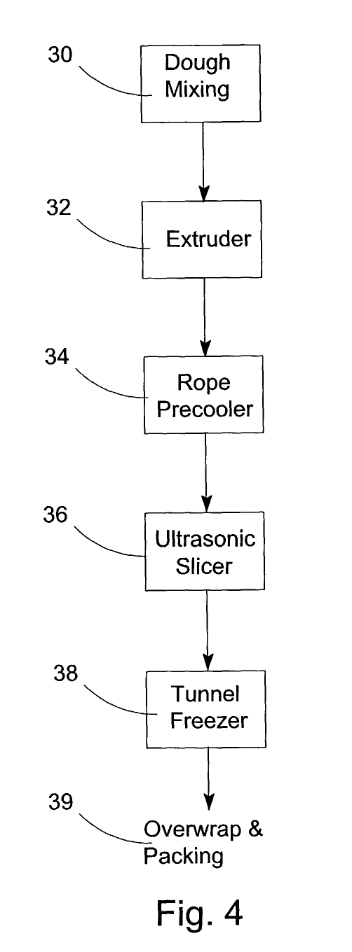

In preparing the dough intermediates of the present invention, three batches of dough are created, first, second and third portions, and reference is directed to the process steps shown in FIG. 4. While in the present embodiment, on three dough streams are provided it is to be understood that more than three streams of dough can be used in creating designs in the cookie dough intermediate.

The dough is mixed at step 30 in accordance with the above-mentioned formula and is prepared in a conventional manner, such as by first blending the sugar and shortening together to create sort of a thick “cream” and then adding a wet of ingredients (water, vanilla, salt) to the “cream” mixture. This combination is then mixed with flour to produce the dough. The dough used in the present invention should have a density ranging from 0.8 to 1.2 and more preferably from 1 to 1.1. In addition, the pH of the dough is preferably around 8, or near the pH of the large portion of the ingredients (flour, sugar).

Once the dough is formed each of the dough batches (individual batches may contain different colors or properties such as a dough that will be crispy or chewy after baking) are fed into an extruder such as a Bepex extruder available from Bepex GmBh of Leingarten, Germany. The extruder 32 combines the multiple dough streams into a rope or tube and the rope may then cooled by the rope precooler 34. The extrusion temperature of the dough is approximately 40 to 75° F. and more preferably between 50 and 70° F. Extrusion is performed at a speed of more than ten feet per minute.

Depending on the temperature of the rope after extrusion, the rope may be cooled and if cooling is provided it can be accomplished by a number of methods such as by an air blast, holding the dough in a chamber at a reduced temperature or by other means. In the present invention, an air blast is used and the dough rope is cooled to between 40 and 65° F. with approximately 40-55° F. being preferred. Cooling time ranges from roughly thirty seconds to two minutes.

Next, the dough rope, having a predetermined temperature travels to a cutting station 36. There are many cutting devices that can be used and these include mechanical or reciprocating knifes and blades, saw and even ultrasonic cutters can be used. The cutting device should operate at a sufficient speed so as to eliminate smearing of the integral design and enable the dough rope to be cleanly sliced into individual pucks or cookie pieces. The cutting is performed at greater than 60 cuts per minute and preferably greater than 2,000 cuts per minute. Cutting speed can vary depending on the temperature of the dough rope. The individual pucks are cut to a width ranging from ¼″ to 1″ and more preferably from ⅜″ to about 1″.

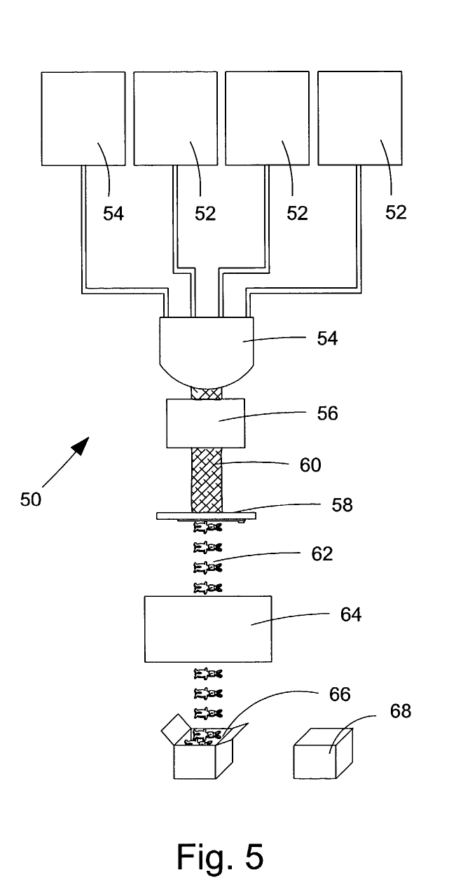

From the cutter 36, the individual cookie pucks are moved away from the cutter through the use of a moving conveyor belt (see FIG. 5) that travels at greater than 20 feet per minute. The difference in speed between the conveyor belt and the extruder enables the individual pucks to be separated from one another as they move toward the next station and away from the extruder. Next, the pucks are moved through a tunnel freezer 38 where the cookie dough intermediates are further cooled and frozen. As the shaped cookie dough intermediate is now of a single thickness, that of the width of the cookie, cooling of the dough occurs more quickly than when the dough is in a rope or tube.

Once the shaped cookie dough intermediates 10 have been frozen, the intermediates are placed in trays, wrapped in protective films and placed in cartons 39 for shipping and storage. Each tray can preferably have between 12 and 24 pucks but other permutations are possible, such as combinations divisible by 2, 3 5 and so on.

Turning now to FIG. 5, a schematic of the apparatus, is generally depicted by reference numeral 50, that is used in making the shaped cookie dough intermediates is provided. The schematic provides a number of dough hoppers 52 that feed an extruder 54. The dough is extruded at more than 10 feet per minute and at a temperature ranging from 40 to 75° F.

In FIG. 5, four dough hoppers 52 are depicted, and depending on the actual design of the cookie dough intermediate only 3 dough streams or types may be used or alternatively more hoppers may be provided. The dough from the hoppers 52 are fed to an extruder 54, identified above. The dough streams emerge from the extruder 54 in a rope 60 in a pre-configured external configuration (other than generally circular) having an internal design (not shown) that is formed by specific dough streams being fed to different dies (not shown) within the extruder 54. For example, the position that the first portion 16 (FIG. 1) will hold in the die relates to the external shape of the shaped cookie dough intermediate, the second portion 12 (FIG. 1) will result in the formation of the interior of the ears of the rabbit 10, the third portion 14 (FIG. 1) will form the eyes in the rabbit, and so forth. In other embodiments the dough from the hoppers 52 may form decorations on a holiday tree as well as the external shape.

Depending on the extrusion temperature of the dough rope, the rope 60 of preformed and pre-configured dough intermediate may be fed through a pre-cooler 56 that cools the dough rope intermediate to 40 to 65° F. to reduce the temperature of the dough. The dough temperature aids in reducing the smearing of the individual dough streams or portions into another area during the cutting of the dough rope at station 58.

The dough rope intermediate 60 is then fed to the cutter 58 that moves at a high rate of speed to create the individual pucks or slices to create the shaped cookie dough intermediate. The cutter operates at greater than 500 cuts per minute and preferably greater than 2,000 cuts per minute and produces pucks of shaped cookie dough intermediates 62 ranging in thickness from ¼″ to 1″ depending on the demands of the design. The cutter 58 does not smear the dough streams and as such, the pucks 62 of cookie dough intermediate emerge from the cutter 58 with the full design visible 62.

After the shaped cookie dough intermediates 62 leave the cutter 58, they travel to a tunnel freezer 64 where the pucks 62 are frozen. After freezing, the pucks 62 then move to a packaging station 66 and may be placed in trays or boxes prior to being shipped 68 for distribution or storage.

In addition to the trays or boxes of shaped cookie dough intermediates, the trays may be provided with supplemental items such as a decorating kit, candy sprinkles, frosting tubes and the like so that the consumer may add additional decoration to the cookies after the intermediate has been baked.

It will thus be seen according to the present invention a highly advantageous cookie dough intermediate having a integral, preformed extruded design has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

1. A generally non-circular cookie dough intermediate having an integral design element, comprising;
a dough intermediate, having first and second sides;
an integral design element;
said dough intermediate having at least first and second portions, said first portion of said dough intermediate is a dough and is provided in an amount of up to 80% of said dough intermediate, and said first portion of said dough intermediate having a first property;
said second portion of said dough intermediate being a dough and is provided in an amount ranging from 1 to 60% of said dough intermediate, and said second portion having a second property distinct from said first property; and
wherein said at least first and second portions of said dough intermediate combine together to form a dough intermediate having a shaped external configuration other than generally circular and said integral design element that is visible on each of said first and second sides.

2. A generally non-circular cookie dough intermediate having an integral design element as recited in claim 1, wherein said first and second property is color.

3. A generally non-circular cookie dough intermediate having an integral design element as recited in claim 1, wherein said first property will produce a crispy texture upon baking.

4. A generally non-circular cookie dough intermediate having an integral design element as recited in claim 1, wherein said second property will produce a chewy texture upon baking.

5. A generally non-circular cookie dough intermediate having an integral design element as recited in claim 1, wherein said dough intermediate includes a third portion provided in amount of less than 40% of said dough intermediate.

6. A generally non-circular cookie dough intermediate having an integral design element as recited in claim 1, wherein said second portion is provided in amount ranging from 10 to 30% of said dough intermediate.

7. A generally non-circular cookie dough intermediate having an integral design element as recited in claim 1, wherein said first portion forms an external shape of said cookie dough intermediate and said second portion forms the integral design element of said cookie dough intermediate.

8. A generally non-circular cookie dough intermediate having an integral design element as recited in claim 1, wherein said cookie dough intermediate is provided with a fourth portion and said fourth portion is provided in an amount up to 40% of said cookie dough intermediate.

9. A generally non-circular cookie dough intermediate having an integral design element as recited in a claim 1, wherein said first property has a first flavor and said second property has a second flavor.

10. A generally non-circular cookie dough intermediate having an integral design element as recited in a claim 1, wherein said first portion is provided in an amount of up to 66% of said dough intermediate and said second portion is provided in an amount ranging from 2 to 40% of said dough intermediate.

11. A generally non-circular cookie dough intermediate having an integral design element as recited in claim 1, wherein said dough intermediate and said integral design cooperate with one another to illustrate a particular theme.

12. A generally non-circular cookie dough intermediate having an integral design element as recited in claim 11, wherein said theme is a holiday theme.

13. A generally non-circular cookie dough intermediate having an integral design element as recited in claim 11, wherein said theme is a seasonal event.

14. A generally non-circular cookie dough intermediate having an integral design element as recited in claim 11, wherein said theme relates to a sporting event.

15. A generally non-circular cookie dough intermediate having an integral design element as recited in claim 1, wherein said dough intermediate has a density ranging between 0.8 and 1.2.

16. A generally non-circular cookie dough intermediate having an integral design, comprising;
a dough intermediate having first and second sides and an external surface extending in a non-circumferential fashion;
a design element integral with said dough intermediate, said design element including a background portion and at least one highlight portion; each of said background portion and said one highlight portion being visible on each of said first and second sides of said dough intermediate, and said background portion making up a majority of said dough intermediate; and
wherein said dough intermediate and said design element combining together to illustrate a particular theme.

17. A generally non-circular cookie dough intermediate having an integral design as recited in claim 15, wherein said background portion is provided in an amount of up to 66% of said dough intermediate.

18. A generally non-circular cookie dough intermediate having an integral design as recited in claim 15, wherein said at least one highlight portion is provided in an amount ranging from 2 to 40% of said dough intermediate.

19. A method of making a generally non-circular cookie dough intermediate having an integral design element, comprising the steps of;
providing a set of predetermined dough ingredients to produce at least first and second doughs having first and second properties and each having a specific dough density, said first dough making up a majority of said first and second doughs and said first and second doughs cooperating to form a generally non-circumferentially extending cookie dough intermediate shape and an integral design element;
extruding said first and second doughs into a rope at an extrusion temperature ranging between 40 to 75° F. having a generally non-circular external configuration and an internal design element;
slicing said rope to create a generally non-circular shaped cookie dough intermediate having a thickness ranging from about ¼″ to 1″, said generally non-circular cookie dough intermediates having first and second sides and said integral design element being visible on each of said first and second sides;
freezing said generally non-circular cookie dough intermediates with said integral design element; and
placing said generally non-circular cookie dough intermediates in a package such that either of said first and second sides may be visible.

20. A method of making a generally non-circular cookie dough intermediate having an integral design element as recited in claim 19, wherein said slicing is done by an ultrasonic slicer.

21. A method of making a generally non-circular cookie dough intermediate having an integral design element as recited in claim 19, wherein said extruding step is accomplished at a temperature ranging from 50 to 60° F.

22. A method of making a generally non-circular cookie dough intermediate having an integral design element as recited in claim 20, wherein said ultrasonic slicer operates at greater than 2000 cuts per minute.

23. A method of making a generally non-circular cookie dough intermediate having an integral design element as recited in claim 19, said generally non-circular cookie dough intermediates are placed in trays in said package.

24. A method of making a generally non-circular cookie dough intermediate having an integral design element as recited in claim 23, wherein said trays have between 12 to 24 of said generally non-circular cookie dough intermediate.

25. A method of making a generally non-circular cookie dough intermediate having an integral design element as recited in claim 19, including a further step of placing a decorating kit within said package after the generally non-circular cookie dough intermediates are placed in the package.

26. A method of making a generally non-circular cookie dough intermediate having an integral design element as recited in claim 19, including a further step of cooling said rope after the step of extruding.
